(19) United States
(12) Patent Application Publication
(10) Pub. No.: US 2026/0118835 A1
(43) Pub. Date: Apr. 30, 2026

(54) CONFIGURABLE PERCEPTUAL CONTROL SYSTEM

(71) Applicant: Moon’s Information Technology Ltd, Windsor (GB)

(72) Inventor: Rupert YOUNG, Windsor (GB)

(21) Appl. No.: 19/373,441

(22) Filed: Oct. 29, 2025

(30) Foreign Application Priority Data
Oct. 30, 2024 (GB) 2415991.5

(51) Int. Cl. G05B 13/02

(52) U.S. Cl. CPC G05B 13/0205

(57) ABSTRACT

A technique of configuring a multi-variable control system, in which the control system is constructed from a hierarchy of perceptual control units and the configuration optimizes the hierarchy using an evolutionary algorithm. A perceptual control system configured in this manner can automatically configure itself to achieve optimal performance, leading to applications in a number of technical fields associated with complex multi-variable systems, such as energy management systems, nuclear fusion plasma control and robotics.

### CROSS-REFERENCE TO RELATED APPLICATIONS

This application is based on and claims priority to United Kingdom Patent Application No. 2415991.5, filed on Oct. 30, 2024, and entitled “Configurable Perceptual Control System,” the disclosure of which is herein incorporated by reference in the entirety.

### TECHNICAL FIELD

The present disclosure relates to control systems for multi-variable systems, and more particularly to a configurable perceptual control system using an optimized hierarchy of perceptual control units.

### BACKGROUND

Control systems play a crucial role in managing complex multi-variable systems across various domains, including robotics, energy management, and industrial processes. These systems are responsible for monitoring and adjusting multiple interconnected variables to achieve desired outcomes or maintain optimal performance. As the complexity of modern systems continues to increase, traditional control approaches often struggle to effectively manage the intricate relationships between numerous variables and adapt to changing conditions.

Perceptual control theory offers an alternative approach to system control, focusing on the regulation of perceptual variables rather than direct manipulation of system outputs. This approach aligns well with the way biological systems, including the human brain, process information and control behavior.

Hierarchical control architectures have emerged as a promising solution to address the challenges of multi-variable system control, and integrating perceptual control principles into hierarchical control architectures can potentially lead to more robust and adaptable control systems. An example of such a hierarchical control system is set out in British patent GB 2,543,082. By organizing control units into multiple levels of abstraction, these architectures can potentially handle complex systems more effectively than flat control structures.

However, determining the optimal hierarchy and configuration of control units remains a significant challenge, often requiring extensive manual tuning and expert knowledge. The challenge grows as multi-variable systems become ever more complex.

### SUMMARY

Embodiments of the present disclosure provide perceptual control systems that can automatically configure themselves, based on a machine-learning process, to achieve optimal performance.

According to an aspect of the present invention, there is provided a configuration module for a multi-variable control system controlled by a plurality of perceptual control units, PCUs, wherein the configuration module is arranged to: configure the plurality of PCUs in an optimized hierarchy, wherein the configuration module is arranged to determine the optimized hierarchy using an evolutionary algorithm; and wherein the optimized hierarchy is such that multi-variable system, when controlled using the optimized hierarchy of the plurality of PCUs, achieves an optimized state.

In embodiments, the evolutionary algorithm comprises: (a) a definition step comprising receiving inputs of the multi-variable system, and a definition of an action space of the multi-variable system; (b) an initialization step comprising configuring a first generation of a population of candidate hierarchical configurations for controlling the multi-variable system by controlling one or more actuators of the action space of the multi-variable system based on at least one of the input variables, wherein for each member of the first generation, each of a respective set of PCUs is randomly assigned to one of the levels of the hierarchy, and the hierarchy comprises a random number of levels and weighting functions of interconnections between PCUs in different levels are randomly assigned; (c) an evaluation step in which control of the multi-variable system by the set of PCUs arranged in the candidate hierarchical configuration is evaluated using a fitness function, for each candidate hierarchical configuration; (d) a reconfiguration step in which a subset of the candidate hierarchical configurations of the first generation having the greatest fitness, derived by the fitness function, are combined and/or mutated to configure a second generation of candidate hierarchical configurations; (e) an optimization step in which the evaluation step is re-applied to the output of the reconfiguration step, and a further reconfiguration step is performed according to the output of the re-applied evaluation step, wherein the optimization step is repeated iteratively until a termination condition for the evolutionary algorithm is reached; wherein optimized hierarchy corresponds to the output of the optimization step at the termination of the evolutionary algorithm.

In embodiments, the termination condition is a predetermined number of iterations of the optimization step, or a threshold level of fitness of a candidate hierarchical configuration being exceeded by a member of the population.

In embodiments, each candidate hierarchical configuration defines: a number of levels of the hierarchy; a number of PCUs in each of the number of levels; and weighting functions of interconnections between PCUs in different levels of the hierarchy.

In embodiments, the configuration module further comprises: an evolutionary algorithm module comprising one or more processors for executing the evolutionary algorithm; a storage module for storing one or more hierarchical configurations of the population, including random hierarchical configurations in which the hierarchy has a random number of levels, PCUs are randomly assigned to levels of the hierarchy, and weighting functions of interconnections between PCUs in different levels are randomly assigned; and an environment interface, coupled to the evolutionary algorithm module, for providing control instructions to one or more actuators of the multi-variable system and for receiving sensor inputs from one or more sensors of the multi-variable system.

In embodiments, the configuration module comprises a user input module for receiving user commands to specify one or more of: constraints to be applied to the evolutionary algorithm; and inputs defining changes to the configuration of the multi-variable system.

In embodiments, the constraints comprise conditions under which the optimized state should be reached and/or parameters of the fitness function.

In embodiments, the configuration module is arranged to determine changes to the environment of multi-variable system and to dynamically re-optimize the hierarchical configuration in response to the determined changes.

According to a second aspect of the present invention, there is provided a control apparatus comprising the configuration module of the first aspect, and the plurality of PCUs, wherein each PCU comprises one or more perception inputs, a reference input, and an output; wherein the PCU comprises a functional unit for deriving an output signal at said output of a given PCU from the perception input, and a reference signal received at said reference input; wherein the reference signal for the given PCU is derived from outputs of one or more PCUs in one or more higher levels of the hierarchy than the given PCU; and the output of at least one of the PCUs is arranged to output an action to an actuator defined by the action space of the multi-variable control system.

In embodiments, each functional unit comprises: a weighting module for applying weighting functions to the perception input and the reference input; and a comparator for comparing the sensor data input and the reference input, weighted by the weighting module to generate an output signal for the output of the PCU.

In embodiments, a PCU in the lowest level of each of the candidate hierarchical configurations of the first generation receives sensor data from the multi-variable system at its perception input.

According to a third aspect of the present invention, there is provided a system comprising a plurality of actuators and a plurality of sensors, wherein the each of the plurality of actuators is arranged to cause a change to one or more variables characterizing the environment of the actuator, and each of the sensors is arranged to determine one or more of the variables; the system further comprising a control apparatus according to any one of the previously described embodiments, the control apparatus arranged to control the plurality of actuators in response to information received from the plurality of sensors.

In embodiments, the environment relates to one of: a robotics system; an energy management system; a nuclear fusion system; a wind turbine system; and an abstraction and reasoning system.

According to a further aspect of the present invention, there is provided a method of configuring control of a multi-variable system using an optimized hierarchy of a plurality of perceptual control units, PCUs, wherein the optimized hierarchy is such that multi-variable system, when controlled using the optimized hierarchy of the plurality of PCUs, achieves an optimized state, the method comprising determining the optimized hierarchy using an evolutionary algorithm comprising: (a) a definition step comprising receiving inputs of the multi-variable system, a definition of an action space of the multi-variable system; (b) an initialization step comprising configuring a first generation of a population of candidate hierarchical configurations for controlling the multi-variable system to achieve the predetermined goal by controlling one or more actuators of the action space of the multi-variable system based on at least one of the input variables, wherein for each member of the first generation, each of a respective set of PCUs is randomly assigned to one of the levels of the hierarchy, and the hierarchy comprises a random number of levels and weighting functions of interconnections between PCUs in different levels are randomly assigned; (c) an evaluation step in which control of the multi-variable system by the set of PCUs arranged in the candidate hierarchical configuration is evaluated using a fitness function, for each candidate hierarchical configuration; (d) a reconfiguration step in which a subset of the candidate hierarchical configurations of the first generation having the greatest fitness, derived by the fitness function, are combined and/or mutated to configure a second generation of candidate hierarchical configurations; (e) an optimization step in which the evaluation step is re-applied to the output of the reconfiguration step, and a further reconfiguration step is performed according to the output of the re-applied evaluation step, wherein the optimization step is repeated iteratively until a termination condition for the evolutionary algorithm is reached; wherein optimized hierarchy corresponds to the output of the optimization step at the termination of the evolutionary algorithm.

According to a fifth aspect of the present invention, there is provided a computer program which, when executed by one or more processors, is arranged to perform the method of the fourth aspect.

### BRIEF DESCRIPTION OF THE DRAWINGS

Embodiments of the present disclosure will be described by way of example only, with reference to the accompanying drawings, of which:

FIG. 1 shows a control system in which a configuration module, according to embodiments of the present invention, is arranged;

FIG. 2 shows a perceptual control unit as used in a control system of FIG. 1;

FIG. 3 shows a method of configuring a control system according to embodiments of the present invention; and

FIG. 4 shows a configuration module according to embodiments of the present invention.

### DETAILED DESCRIPTION

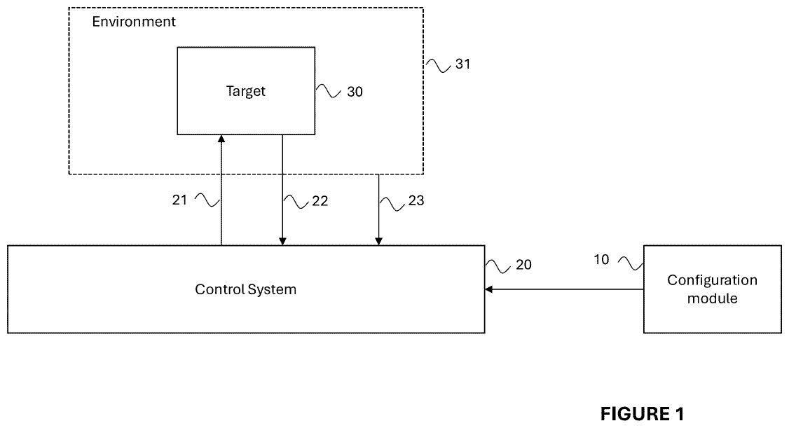

FIG. 1 illustrates an example of a multi-variable control system. The control system acts 20 to control actions of a target 30, the actions defined in an action space associated with the environment 31 in which the target 30 is present. For example, the target 30 may be a vehicle, which is able to be accelerated, via control of motors by the control system 20, in order to move around its environment 31. In this example, the variables of the multi-variable system include at least the position and the velocity of the vehicle. The action space, in this example, corresponds to motion in the environment 31 in a particular direction, at a particular speed, namely an action which can be accomplished by using the control system 20 to apply corresponding control signals to the vehicle. More generally, the target 30 may comprise one or more physical or logical units.

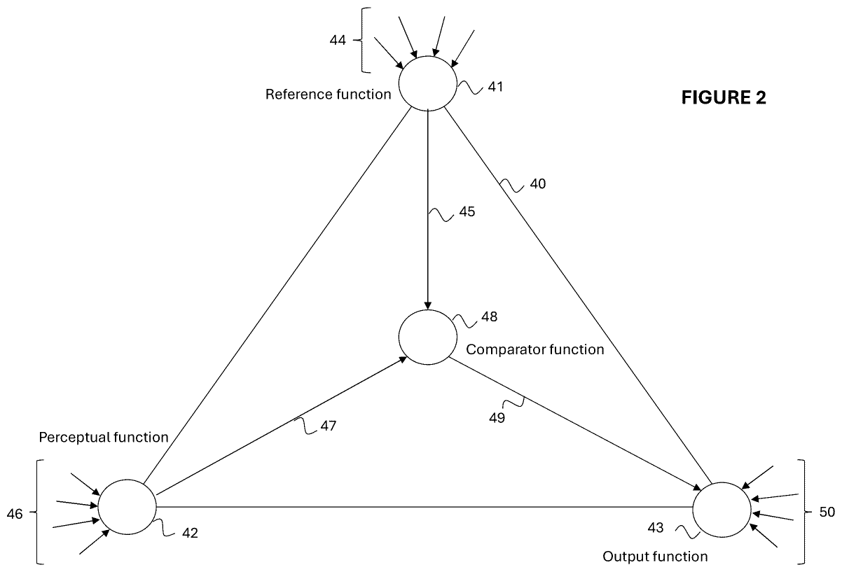

The control system 20 comprises one or more control units, described below with reference to FIG. 2. In the context of embodiments of the present invention, the control units are referred to as perceptual control units (PCUs) 40. A PCU 40 is a functional component within a control system 20 that processes and regulates perceptual variables, and an example of its configuration is shown in FIG. 2. For ease of description, the PCU 40 is represented as a triangular abstraction, having two input functions, namely a reference function 41, and a perceptual function 42, and one output function 43.

The reference function 41 receives one or more references 44 representing goal values of the PCU 40, and generates a reference signal 45 from a combination of the received references 44. The perceptual function 42 receives one or more perceptions 46 from the environment 31 of the target 30 and generates a perceptual signal 47 from a combination of the perceptions 46. The PCU 40 comprises a comparator function 48, which compares the reference signal 45 and the perceptual signal 47, and produces an error signal 49. The output function 43 converts the error signal 49 into one or more outputs 50 representing actions to be applied to the target 30, such that the perceptions 46 are driven towards the goal values 44, whilst resisting environmental disturbances. The output function 43 may be a leaky integrator, having an exponential smoothing function, although alternative output functions may be used. PCUs 40 may be arranged in a hierarchy, in which the reference function 41 of a first PCU takes references 44 from PCUs in one or more higher levels of the hierarchy, and takes perceptions 46 from PCUs in one or more lower levels of the hierarchy. At the lowest level of the hierarchy, the perceptions 46 are taken from sensors in the environment 31 of the target 30, or from the target 30 itself, while the actions 50 provided from the output function 43 are applied to one or more actuators of the target 30.

The sensors may include any type of sensor producing an n-dimensional set of signals, such as, for example, light, sound, vision, GPS, magnetometer, accelerometer, gyroscope. The actuators may be any type of system acting in the real world such as, for example, motors, muscles, lights, speakers.

PCUs 40 in each level of the hierarchy are connected to all other PCUs in different levels. The reference function 41 and perceptual function 42 perform weighted sums of the references 44 and perceptions 46 that they receive, according to weighting functions at the PCU inputs. In some cases, the weighting applied to a particular input may be zero. In some cases, the weightings are configured such that the output of one PCU ‘passes through’ a PCU in a lower level without modification.

Examples of weighting functions employed by the reference function 41 and perceptual function 42 are smooth weighted sums, sigmoid weighted sums, and derivative weighted sums, with weightings as binary or floating point values.

The configuration of the hierarchy is defined by:
the number of levels;
the number of PCUs 40 in each level;
the weighting functions of each PCU input 41, 42.

The configuration module 10 of embodiments of the present disclosure operates to determine an optimal configuration of the hierarchy of PCUs 40, such that they cause the target 30 reach an optimum state. The optimum state may be a predetermined goal, such as position or velocity, or may be determined by the configuration module in a manner to be described in more detail below.

FIG. 2 shows a method of configuring a control system 20 according to embodiments of the present invention. The method is a machine-learning process performed by a configuration module 10 according to embodiments of the present invention, and is based on the application of an evolutionary algorithm (EA) to the structure of the PCU hierarchies.

In step S61, a system definition is performed, comprising receiving a definition of the inputs and the action space of the multi-variable system. For example, the system definition may define that the inputs of the multi-variable system are the position and velocity of a target vehicle, namely measurable parameters whose values are input to the configuration module 10, while the action space defines motion imparted to the vehicle by one or more motors of the vehicle, caused by the control system 20. The system definition of step S61 comprises receiving inputs from a user or a control system, via an interface of the configuration module 10, such that configuration module can be configured to work with any multi-variable system. In the case of a complex multi-variable system, it will be appreciated that the system can be characterized by variables in a much simpler manner than a characterization which is based on models for the behaviors or these variables and their interactions.

In step S62, the EA is initialized. This comprises defining a first generation of a population of candidate hierarchical configurations of PCUs 40 for controlling the multi-variable system defined in step S61. The first generation of candidate hierarchical configurations are random configurations, comprising random numbers of levels, random numbers of PCUs 40 in each level, and random weighting functions for each PCU inputs 41, 42. The first generation of configurations is stored in a hierarchical configuration storge module.

An example of an EA is a genetic algorithm, in which each member of the population can be considered as a genetic representation of a system, such as a chromosome. Chromosomes of typical genetic algorithms are one-dimensional data strings, but in embodiments of the present invention, the genetic representation can be considered as a two-dimensional layout of PCUs 40, in which a hierarchy of PCUs 40 has a number of levels and columns, with particular interconnections of PCUs in one level to PCUs in one or more columns of different level. Columns may align with particular sensors or actuators. PCUs 40 can be considered can be considered to be arranged in a particular column such that their connection lengths are minimized if the PCUs 40 were to be physically laid out according to the two-dimensional hierarchy.

The population may have a predetermined size, for example 100 or 500 members, based on an input to the configuration module 10 as part of the definition step S61, or as an input to the configuration module 10 occurring in step S62 itself.

In step S63, an evaluation is performed as to the performance of each candidate hierarchical configuration. The evaluation is performed by using a fitness function to characterize how the multi-variable system evolves when control inputs are applied to the target of the multi-variable system via each hierarchy of PCUs 40. In this way, the highest-performing hierarchies of PCUs 40 are identified as a subgroup of candidates to be promoted to the reconfiguration step (step S64).

The fitness function which is selected is dependent upon user requirements and the nature of the multi-variable system for which control is to be optimized. The fitness function involves a simulation of the multi-variable system in its environment and yields a fitness score, which can be compared across the different hierarchies. The fitness function can be configured to measure suitability of each hierarchy to drive the multi-variable system towards an optimized state within a user-defined constraint, such as achieving the optimum step most quickly, or with the fewest action inputs, the smallest amount of energy consumed, and so on.

The optimum configurations are those for which the fitness value exceeds a particular threshold. In alternative embodiments, a predetermined number of hierarchies having the highest fitness values are those which are promoted to further stages of the EA, but by using a fitness value threshold, it can be ensured that the best hierarchies have a given performance level.

A reconfiguration step is performed in step S64. In this step, a second generation of candidate hierarchies is generated from the subset of candidates which is identified in step S63. The second generation of candidate hierarchies is generated by mating and/or mutating the candidates of the subset such that the resultant second generation of candidate hierarchies contains new definitions of the number of levels, the number of PCUs 40 per level, and the interconnection weightings of the PCUs 40.

In particular, weighting functions can be mutated or merged to produce the second generation of candidate hierarchies. Additionally, or alternatively, a random choice may be made to either add or remove levels or columns of the hierarchy, requiring unlinking or re-linking of connections between nodes in the first generation of candidate hierarchies.

The fitness function is applied to the second generation of candidate hierarchies by performing a re-evaluation step in step S65 and identifying the best hierarchies to be promoted to the next stage of the EA. The re-evaluation step can be considered as an optimization step in which the set of candidate hierarchies may be refined by excluding yet further candidate hierarchies which do not meet the threshold fitness value, and by seeking to identify candidate hierarchies which have higher fitness values than any hierarchy identified previously.

In step S66, it is determined whether a termination condition for the EA is met. In embodiments, the termination condition is a predetermined number of generations of candidate hierarchies being identified. In alternative embodiments, the termination condition is a target fitness value being exceeded by a candidate hierarchy. It the termination condition is met (S66—Y), the hierarchy with the highest score is output (step S67) as the optimized configuration of the multi-variable control system 20. If the termination condition is not met (S66—N), a further step of reconfiguring the population of candidate hierarchies is performed, and the process returns to step S64.

The configuration which is output in S67 is implemented by the configuration module for control of the multi-variable system. The implementation is achieved by configuring a processing platform to be logically arranged according to the hierarchal configuration of PCUs 40 output by the EA. For example, a processing algorithm is configured based on a combination of functional groups of computer-executable functions, so that information flow between the different functional groups is in accordance with the hierarchy of PCUs 40, and with the computer-executable functions representing connections from the PCUs 40 in the lowest level of the hierarchy to one or more actuators of the target 30, and one or more sensors of the target 30 and/or the environment 31. The representation of connections to sensors and actuators is via an environmental interface of the configuration module 10 which outputs and inputs control actions and measured values respectively, providing information to or from the processing algorithm hosted by the multi-variable control system 20.

In embodiments, the perceptual function 42 provides an output signal to a PCU 40 in a higher level of the hierarchy, as well as providing the perceptual signal 47 to the comparator function 48 based on a weighting function applied to the perceptions 46. The output signal may be the same as the perceptual signal 47, or may represent the output of a different perceptual function 42.

At the highest level of the hierarchy, the reference function 41 of the one or more PCUs may receive a predetermined reference value from an input to the configuration module 10 such as a predetermined setting. Alternatively, the reference function 41 at the highest level may be permitted to evolve over time. Additionally, the perceptual function 42 of the one or more PCUs 40 may receive an input directly from the target and/or the environment 31, rather than from a PCU 40 in a lower level of the hierarchy. In this manner, the hierarchy can be initialized from the highest level, with the output function 43 of each PCU 40 feeding a PCU 40 in one or more lower-level PCUs.

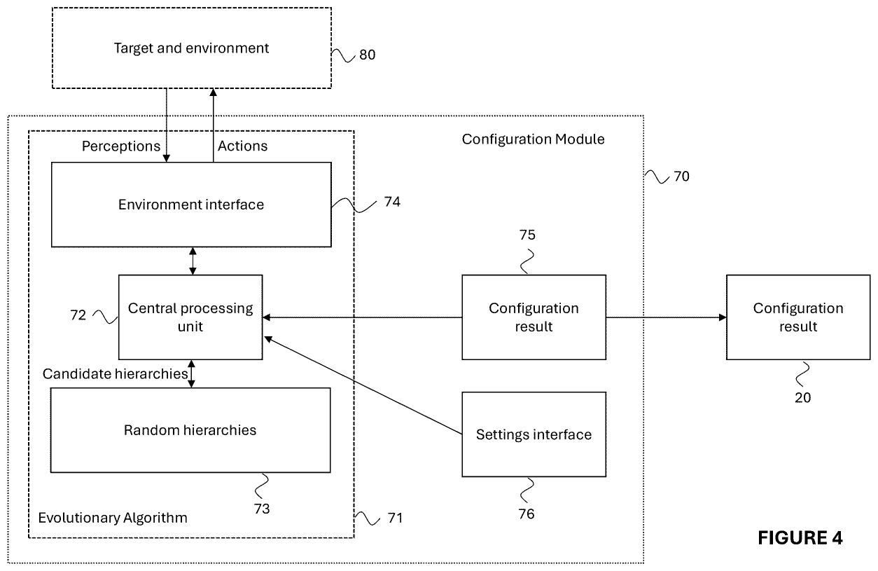

FIG. 4 illustrates a configuration module 70 according to embodiments of the present invention. The configuration module 70 illustrated in FIG. 4 is compatible with the system illustrated in FIG. 1 and may be used to configure the multi-variable control system 20. The multi-variable control system 20 is illustrated in FIG. 4 using the same reference sign as that shown in FIG. 1.

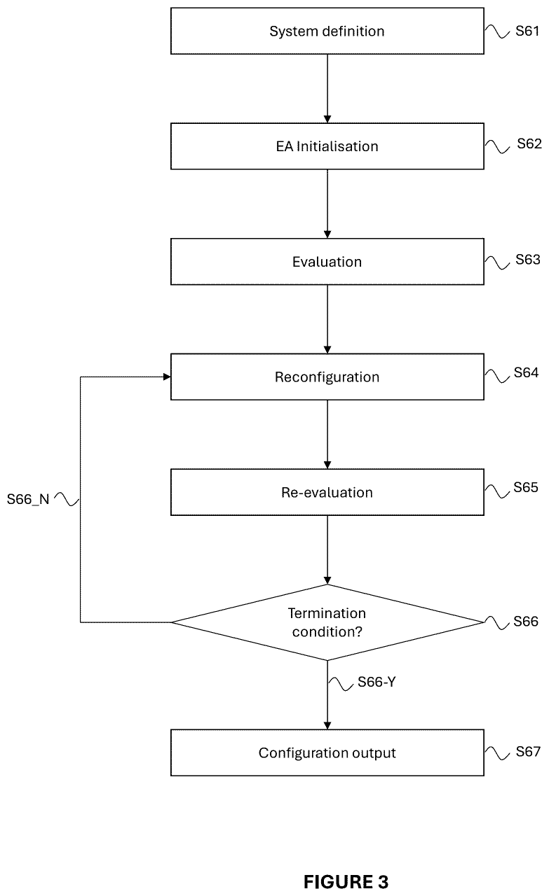

The configuration module 70 comprises an evolutionary algorithm module 71, in which the evolutionary algorithm described with reference to FIG. 3 is executed by a central processing unit (CPU) 72 or controller. The EA operates to determine an optimum hierarchy of PCUs 40 for the multi-variable control system 20. The optimum hierarchy is output as a configuration result 75, which is stored for output to the multi-variable control system 20 for its configuration. The EA module 71 comprises an environment interface 74 which is a virtual interface to a virtual target/environment system 80, used in the simulation of the operation a candidate PCU hierarchy. The environment interface 74 outputs simulated actions to the simulated target 80, and receives simulated perceptions from the simulated target and/or its environment 80, and communicates with the CPU 72 which performs an evaluation step as described in step S63 of FIG. 3 to identify candidate hierarchies which have the highest fitness value, as described above in relation to FIG. 3. The CPU 72 also performs the reconfiguration and re-evaluation steps S64 and S65 of FIG. 3.

The EA module 71 also comprises a storage means 73 for storing random hierarchies used to initialize the EA, as described in step S62 of FIG. 3.

The configuration module 70 comprises a settings interface 76 which acts to receive particular configuration settings for input to the CPU 72 for tuning the EA in accordance with particular parameters, and defining the nature of the initialization step S62 of FIG. 3. For example, the settings interface 76 may define the size of each generation of candidate hierarchies, the termination condition for the EA, the fitness function, a predetermined system goal, and one or more constraints associated with achieving an optimum state.

Connections to the environment can be unspecified so that in each population, each member connects to all sensors in the environment, or a selection of them can be specified.

Although PCUs 40 are described as being arranged in hierarchies, in which each PCU is at a particular level, in alternative embodiments, it is possible to configure a PCU which is distributed over multiple levels, within individual nodes of the PCU (perceptual function 42, output function 43 and reference function 44 and comparator function 48) being arranged on different levels from each other, such that hierarchical configurations of nodes are generated in each population, rather than requiring all nodes of a single PCU 40 to be at the same level of the hierarchy. If such configurations are permitted via the settings interface 76, the range of potential candidate hierarchical configurations is significantly increased, which may accelerate achievement of optimal solutions.

In the present disclosure, the phrase ‘optimum state’ is to be interpreted as including the predetermined system goal, but in embodiments, the optimum state is determined by the CPU 72 itself. The settings interface 76 may be a user interface on a device hosting the configuration module 70, such as computer terminal or device such as a mobile phone or tablet device.

In embodiments in which a predetermined system goal is provided, the goal depends on a priori knowledge of the multi-variable system to be controlled. Examples of particular contexts in which the configuration module 70 may be arranged are a wind turbine system or network, a robotics system, an energy management system, a nuclear fusion system, and an abstraction and reasoning system, but these are presented simply by way of example. In general, the multi-variable systems to which the control system 20 is particular suited are complex systems which are difficult to configure with conventional control systems such as those based on reinforcement learning, which are configured to generate a particular output based on a particular input. As the number of variables in the system increases, the interrelationship between the variables becomes complex and behaviors of individual variables may become unstable. A nuclear fusion system, for example, may become volatile very quickly if any of its parameters drifts outside particular operating ranges, and a control system which is able to anticipate such drifts and take corrective or preventative action is desirable. The configuration module 70 of embodiments of the present disclosure is able to configure a control system 20 for this purpose, among other optimizations, with only minimal system specifications via the settings interface 76. For example, the variables of the multi-variable system are input, their action space is defined, and a system goal, such as a stable power output generation, can be specified via the settings interface 76, and the configuration module 10 determines an optimum control arrangement given these inputs which ensures stable power generation.

The use of PCUs 40 the control system 20 ensures that the control system can be configured without predefined knowledge of the specific nature of the behaviors or any of the variables. The EA is such that the control configuration is developed iteratively until a configuration is obtained in which an optimum state is perceived at the PCU perceptual functions 42. This enables the control system 20 to be used with a variety of different multi-variable control system with only minimal knowledge of the system itself. For example, for a mechanical control system, the configuration module 70 may be provided only with high level goals such as three-dimensional co-ordinates, and a control configuration is developed which moves a target towards those goals without the need for any kinematics computations or models.

The EA module 71 may operate periodically or continuously during control of a multi-variable system by the control system 20 configured by the configuration module 70. This enables re-assessment of the configuration of the control system 20, and the optimum state, to take account of variations to the system not previously accounted for. For example, an external environmental change, such as the introduction of an object into the environment of a target, or a failure of a component, may cause the initial configuration of the control system 20 to become sub-optimal, such that either a new system goal is required, or the optimum configuration of the control system to achieve the original system goal needs to be changed. By re-assessing the target and its environment 80, based on perceptual inputs to the control system 20, it can be determined that optimal behavior is dynamically, and automatically, maintained. In comparison with a conventional control system in which the mappings between inputs and outputs may require significant adjustment in the event of an environmental change, the EA used by the configuration module 70 of the embodiments of the present disclosure is such that the fitness function which is used to assess optimum PCU hierarchies operates without change in the event of an environmental change—the configuration module 70 executes the same EA and simply selects the best PCU hierarchies in view of the simulation performed. In order to adapt the simulation, information defining the nature of the system change is all that is required to be provided to the configuration module 70. Such information can be provided manually via the settings input 76, may be communicated directly by the target or the environment to the CPU 72, or may be inferred through perceptions 46 of the control system 20, such as temperature changes.

It will be appreciated that a variety of modifications to the configuration modules 10, 70 described herein are possible, without departing from the scope of the disclosure.

A number of different specifications and constraints may be applied, in the context of a variety of different system types, but the use of an EA in the automatic, machine learning-based development of a control system to achieve an optimum state, as described in the present disclosure, remains a common principle. Use of an EA leads to significant advantages in comparison with those achieved using reinforcement learning techniques, in terms of the speed at which an optimum state can be achieved, stability and robustness of the solutions produced, and the number of PCUs and the computational resources required to implement the optimal solution. As such, the embodiments of the present disclosure are particular suitable for modelling and controlling complex multi-variable systems.

In some embodiments, a control system may be integrated with the configuration module to present a dynamic self-configuring perceptual control system which can be coupled to a particular target in a particular environment, via sensor and actuator connections. In embodiments, the sensors and actuators may already by integral with the target, such as motors or heaters, and voltage or temperature measurements, and so on. In alternative embodiments, the sensors and/or actuators are part of the control system, so that an otherwise passive target can be manipulated in a particular environment so that it can achieve an optimum state by defining an action space and retrofitting the means for manipulating the target in that action space, in an optimum manner, to the target.

1. A configuration module for a multi-variable system controlled by a plurality of perceptual control units (PCUs) wherein the configuration module is configured to:
configure the plurality of PCUs in an optimized hierarchy, wherein the configuration module is configured to determine the optimized hierarchy using an evolutionary algorithm; and
wherein the optimized hierarchy is such that the multi-variable system, when controlled using the optimized hierarchy of the plurality of PCUs, achieves an optimized state.

2. The configuration module according to claim 1, wherein the evolutionary algorithm comprises:
(a) a definition step comprising receiving inputs of the multi-variable system, and a definition of an action space of the multi-variable system;
(b) an initialization step comprising configuring a first generation of a population of candidate hierarchical configurations for controlling the multi-variable system by controlling one or more actuators of the action space of the multi-variable system based on at least one of the input variables, wherein for each member of the first generation, each of a respective set of PCUs is randomly assigned to one of the levels of the hierarchy, and the hierarchy comprises a random number of levels and weighting functions of interconnections between PCUs in different levels are randomly assigned;
(c) an evaluation step in which control of the multi-variable system by the set of PCUs arranged in the candidate hierarchical configuration is evaluated using a fitness function, for each candidate hierarchical configuration;
(d) a reconfiguration step in which a subset of the candidate hierarchical configurations of the first generation having the greatest fitness, derived by the fitness function, are combined and/or mutated to configure a second generation of candidate hierarchical configurations;
(e) an optimization step in which the evaluation step is re-applied to the output of the reconfiguration step, and a further reconfiguration step is performed according to the output of the re-applied evaluation step, wherein the optimization step is repeated iteratively until a termination condition for the evolutionary algorithm is reached;
wherein optimized hierarchy corresponds to the output of the optimization step at the termination of the evolutionary algorithm.

3. The configuration module according to claim 2, wherein the termination condition is a predetermined number of iterations of the optimization step, or a threshold level of fitness of a candidate hierarchical configuration being exceeded by a member of the population.

4. The configuration module according to claim 2, wherein each candidate hierarchical configuration defines:
a number of levels of the hierarchy;
a number of PCUs in each of the number of levels; and
weighting functions of interconnections between PCUs in different levels of the hierarchy.

5. The configuration module according to claim 2, further comprising:
an evolutionary algorithm module comprising one or more processors for executing the evolutionary algorithm;
a storage module for storing one or more hierarchical configurations of the population, including random hierarchical configurations in which the hierarchy has a random number of levels, PCUs are randomly assigned to levels of the hierarchy, and weighting functions of interconnections between PCUs in different levels are randomly assigned; and
an environment interface, coupled to the evolutionary algorithm module, for providing control instructions to one or more actuators of the multi-variable system and for receiving sensor inputs from one or more sensors of the multi-variable system.

6. The configuration module according to claim 5, further comprising a user input module for receiving user commands to specify one or more of:
constraints to be applied to the evolutionary algorithm; and
inputs defining changes to the configuration of the multi-variable system.

7. The configuration module according to claim 6, wherein the constraints comprise conditions under which the optimized state should be reached and/or parameters of the fitness function.

8. The configuration module according to claim 1, wherein the configuration module is configured to determine changes to the environment of multi-variable system and to dynamically re-optimize the hierarchical configuration in response to the determined changes.

9. The control apparatus comprising the configuration module of claim 1, and the plurality of PCUs, wherein each PCU comprises one or more perception inputs, a reference input, and an output;
wherein the plurality of PCUs comprises a functional unit for deriving an output signal at said output of a given PCU from the perception input, and a reference signal received at said reference input;
wherein the reference signal for the given PCU is derived from outputs of one or more PCUs in one or more higher levels of the hierarchy than the given PCU; and
the output of at least one of the PCUs is configured to output an action to an actuator defined by the action space of the multi-variable control system.

10. The control apparatus according to claim 9, wherein each functional unit comprises:
a weighting module for applying weighting functions to the perception input and the reference input; and
a comparator for comparing the sensor data input and the reference input, weighted by the weighting module to generate an output signal for the output of the PCU.

11. The control apparatus according to claim 9, wherein a PCU in the lowest level of each of the candidate hierarchical configurations of the first generation receives sensor data from the multi-variable system at its perception input.

12. A system comprising a plurality of actuators and a plurality of sensors,
wherein the each of the plurality of actuators is configured to cause a change to one or more variables characterizing an environment of the actuator, and each of the sensors is configured to determine one or more of the variables;
the system further comprising a control apparatus according to claim 9, the control apparatus configured to control the plurality of actuators in response to information received from the plurality of sensors.

13. The system according to claim 12, wherein the environment relates to one of:
a robotics system;
an energy management system;
a nuclear fusion system;
a wind turbine system; and
an abstraction and reasoning system.

14. A method of configuring control of a multi-variable system using an optimized hierarchy of a plurality of perceptual control units, PCUs, wherein the optimized hierarchy is such that multi-variable system, when controlled using the optimized hierarchy of the plurality of PCUs, achieves an optimized state, the method comprising determining the optimized hierarchy using an evolutionary algorithm, the evolutionary algorithm comprising:
(a) a definition step comprising receiving inputs of the multi-variable system, a definition of an action space of the multi-variable system;
(b) an initialization step comprising configuring a first generation of a population of candidate hierarchical configurations for controlling the multi-variable system to achieve the predetermined goal by controlling one or more actuators of the action space of the multi-variable system based on at least one of the input variables, wherein for each member of the first generation, each of a respective set of PCUs is randomly assigned to one of the levels of the hierarchy, and the hierarchy comprises a random number of levels and weighting functions of interconnections between PCUs in different levels are randomly assigned;
(c) an evaluation step in which control of the multi-variable system by the set of PCUs arranged in the candidate hierarchical configuration is evaluated using a fitness function, for each candidate hierarchical configuration;
(d) a reconfiguration step in which a subset of the candidate hierarchical configurations of the first generation having the greatest fitness, derived by the fitness function, are combined and/or mutated to configure a second generation of candidate hierarchical configurations;
(e) an optimization step in which the evaluation step is re-applied to the output of the reconfiguration step, and a further reconfiguration step is performed according to the output of the re-applied evaluation step, wherein the optimization step is repeated iteratively until a termination condition for the evolutionary algorithm is reached;
wherein optimized hierarchy corresponds to the output of the optimization step at the termination of the evolutionary algorithm.

15. The non-volatile computer-readable storage medium comprising computer-executable instructions which, when executed by one or more processors, cause the one or more processors to perform the method of claim 14.

16. A robotics system comprising a plurality of actuators and a plurality of sensors,
wherein the each of the plurality of actuators is configured to cause a change to one or more variables characterizing an environment of the actuator, and each of the sensors is configured to determine one or more of the variables;
the robotics system further comprising a control apparatus according to claim 9, the control apparatus configured to control the plurality of actuators in response to information received from the plurality of sensors.

17. A energy management system comprising a plurality of actuators and a plurality of sensors,
wherein the each of the plurality of actuators is configured to cause a change to one or more variables characterizing an environment of the actuator, and each of the sensors is configured to determine one or more of the variables;
the energy management system further comprising a control apparatus according to claim 9, the control apparatus configured to control the plurality of actuators in response to information received from the plurality of sensors.

18. A nuclear fusion system comprising a plurality of actuators and a plurality of sensors,
wherein the each of the plurality of actuators is configured to cause a change to one or more variables characterizing an environment of the actuator, and each of the sensors is configured to determine one or more of the variables;
the nuclear fusion system further comprising a control apparatus according to claim 9, the control apparatus configured to control the plurality of actuators in response to information received from the plurality of sensors.

19. A wind turbine system comprising a plurality of actuators and a plurality of sensors,
wherein the each of the plurality of actuators is configured to cause a change to one or more variables characterizing an environment of the actuator, and each of the sensors is configured to determine one or more of the variables;
the wind turbine system further comprising a control apparatus according to claim 9, the control apparatus configured to control the plurality of actuators in response to information received from the plurality of sensors.

20. A abstraction and reasoning system comprising a plurality of actuators and a plurality of sensors,
wherein the each of the plurality of actuators is configured to cause a change to one or more variables characterizing an environment of the actuator, and each of the sensors is configured to determine one or more of the variables;
the abstraction and reasoning system further comprising a control apparatus according to claim 9, the control apparatus configured to control the plurality of actuators in response to information received from the plurality of sensors.
